(19) United States
(12) Patent Application Publication
(10) Pub. No.: US 2022/0051118 A1
(43) Pub. Date: Feb. 17, 2022

(54) SITE CHARACTERIZATION FOR AGRICULTURE

(71) Applicant: Landscan, LLC, Lake Oswego, OR (US)

(72) Inventors: Daniel James Rooney, Lake Oswego, OR (US); Stephen Farrington, Stockbridge, VT (US); Jeffery Winget Dlott, Santa Cruz, CA (US); Woody Guthrie Wallace, Madison, WI (US)

(21) Appl. No.: 17/404,470

(22) Filed: Aug. 17, 2021

Related U.S. Application Data
(60) Provisional application No. 63/066,753, filed on Aug. 17, 2020.

(51) Int. Cl. G06N 7/00; G06Q 10/06; G06Q 30/02; G06Q 50/02

(52) U.S. Cl. CPC G06N 7/005; G06Q 50/02; G06Q 30/0205; G06Q 10/06315

(57) ABSTRACT

Methods, systems, and apparatus, including computer programs encoded on computer storage media, for characterization of a physical site. One of the methods includes obtaining, for each of one or more physical locations corresponding to a respective coordinate at a surface of a growing medium at the locations, sensor data comprising a sensor profile generated from measurements taken by each of a plurality of sensors on a sensor unit passing through the respective coordinate at a plurality of different depth levels within the growing medium at the location; providing the sensor data as input to one or more probabilistic models configured to receive the sensor data comprising the respective sensor profiles to predict one or more characteristics of the growing medium at each of the physical locations; and obtaining, as output from the one or more probabilistic models, the one or more predicted characteristics for each physical location.

### CROSS-REFERENCE TO RELATED APPLICATION

This application claims the benefit of the filing date of U.S. Application No. 63/066,753, filed on Aug. 17, 2020. The disclosure of the prior application is considered part of and is incorporated by reference in the disclosure of this application.

### TECHNICAL FIELD

This specification relates generally to a method, system, and computer program product for characterizing, analyzing, and, optionally, managing a physical site. More particularly, this specification relates to a method, system, and computer program product for characterizing, analyzing, and, optionally, managing a physical site in agriculture or forestry.

### BACKGROUND

This specification generally relates to obtaining sensor data and predicting characteristics of physical sites, and implementing management methods and systems using machine learning.

A physical site can be sub-divided into a plurality of “blocks” which are typically characterized as a field in the physical site in which plants are grown or could be grown. Bulk data can be collected from each block using one or more sensors to identify characteristics for the block.

A machine learning model receives input and generates an output based on the received input and on values of the parameters of the model. The parameter values can be trained according to various machine learning techniques, to find values of the parameters that result in a more accurate output for a given input. The machine learning model may include a single layer of linear or non-linear operations, or include multiple layers of non-linear operations.

### SUMMARY

This specification describes technologies, methods, and systems for obtaining sensor data for a physical site and inferring, deriving or predicting characteristics for the physical site, including characteristics of present and future plants or animals grown in the region. These technologies generally involve obtaining, at different physical locations in a region, sensor data.

The sensor data includes raw signals and measurements of characteristics of the physical locations using contact and/or non-contact sensors, including surface-level characteristics, sub-surface level characteristics, remote data from drones, planes or satellites and other characteristics ubiquitous to the region, such as weather conditions. The combination of geo-spaciotemporal data can be aggregated into “data cores” incorporating imagery collected from satellites, planes, drones, with subsurface sensor data including imagery through the root zone. Data cores could include measured, inferred, derived, or predicted characteristics in addition to imagery. The sensor data is provided to one or more machine learning models that are configured to receive the sensor data and to predict characteristics of the region at the physical locations, including characteristics that are not represented in the sensor data measured at the physical site, and characteristics that are measured for at some, but not all, locations at the physical site.

Inferred, derived or predicted characteristics can include characteristics that were measured by different sensors, e.g., sensors for classifying soil texture, but “sharpened” to provide more accurate measurements by combining the separate measurements. The characteristics can also include latent characteristics that are not directly measured by the different sensors, but are inferred, derived or predicted by the machine learning models based on learned correlations between other, directly measured, characteristics, e.g., a maximum water holding capacity for a growing medium predicted given measured characteristics for moisture content and the quantification of different layers in the growing medium. The growing medium may be soil, or it may be another type of material. The described techniques for site characterization can result in identifying numerous and complex interactions, relationships, or correlations between directly measured characteristics of a physical site, which can further result in new or refined inferred, derived, or predicted characteristics.

The inferred, derived or predicted characteristics and additional external constraints, such as socio-economic data, or a defined objective for a physical site, such as an expected plant yield at the end of a season, can be used to generate recommendations for “best practices” and dynamic management methods and systems in maintaining and managing a physical site, so as to satisfy the external constraints or achieve the defined objective.

Recommendations can be automatically translated into a set of instructions for controlling agronomic or forestry management equipment, such as irrigation systems, fertilization systems, and pest control systems, to result in changes of a physical site's management to a level of precision previously considered intractable or can be recommendations related to manually managed activity such as when to harvest. Rather than manage a physical site at a block level, i.e., by sweeping management decisions that generalize an inherently heterogeneous block, the provided site characterization and predicted characteristics can offer a granularity for a recommendation system to generate decisions or recommendations for managing a smaller portion of a region, e.g., row of trees in an orchard, grouping of vines in a vineyard, cluster of annual plants in a field, or individual trees, vines, plants, or animals in a physical site, or even to a plant organ level such as leaves, shoots, roots, or fruit.

Generally, these smaller portions of a region are referred to as “management units.” Management units can include the smallest possible area that a human or machine management method or system can act on. Management units can be defined according to one or more characteristics for the portion of the region represented by the management unit. For example, management units can be characterized by biological, chemical, geological, topographical, weather and climate, socio-economic, and other scientific, technical, business, and financial characteristics.

Management units can be temporally dynamic. In other words, the portion of the region represented by the management unit can vary according to temporal variation in the characteristics defining the unit. The productivity or other performance measures of physical sites can be optimized over time through the dynamic implementation of management methods and systems on one or more management units representing a region.

For example, if a management unit represents a fixed economic value, then depending on economic conditions, the size of the region represented by the management unit changes as a function of the amount of region matching that fixed value. One thousand dollars in lemons may correspond to a management unit of 10 lemon trees during the peak season of lemon production. Later, the same management unit can represent 20 lemon trees, for example during the off-season as the value of lemons decreases.

As another example, management units representing a labor cost to maintain the region represented by the units can also result in the units changing over time, e.g., because labor costs can vary over time with socio-economic conditions. As another example, improvements in technology can affect management units defined by the yield of the region represented by the units. As technology for planting, cultivation, and harvesting improve, the portion of the region represented by a unit can increase because the same amount of labor and other resources can be used to greater effect.

Previously, defining management units smaller than a block within a physical site was imprecise for site characterization or subsequent agronomic recommendations for managing the site, because sensor data collected and analyzed for characterizing a site was collected at a level not granular enough to guide informed decisions about how best to manage a management unit at the level of, for example, a row of grapes within a vineyard or an individual grapevine. The incorporation of market conditions or other socio-economic characteristics, e.g., pricing, labor availability, or export demand, has also had limited utility in defining management units due to the lack of methods and systems to accurately and dynamically combine key characteristics in a timely manner to inform or make management decisions. By techniques described in this specification, sensor data can be collected and analyzed to provide inferred, derived or predicted characteristics for individual plants or other management units that are smaller than an individual block in a site.

The subject matter described in this specification can be implemented in particular implementations so as to realize one or more of the following advantages. The granularity of the obtained sensor information allows for more information to be obtained to drive new or more refined characterization of a region. As a result, predictive techniques, such as artificial intelligence, including machine learning and neural networks, can be trained for higher accuracy than previous techniques that included obtaining bulk sensor data at the block level. The additional variability including heterogeneity, complexity, and scale of information received is well-suited for quantum computing techniques, which can process and generate inferred, derived, or predicted characteristics for highly variable characteristics, such as weather patterns. In an illustrative embodiment, a method includes evaluating, using a quantum processor and quantum memory, sensor data or predicted characteristics from a probabilistic model. In another illustrative embodiment, a quantum processor not only processes input sensor data or output predicted characteristics but may also or alternatively be integrated in a machine learning process for quantum-enhanced machine learning wherein, based on one or more defined configurations of qubits and quantum operations or specialized quantum systems, computational speeds and data storage or one or more machine learning algorithms may be enhanced. This may be achieved by, for example, hybrid classical-quantum computing systems which outsource computationally intensive subroutines of classical processors to one or more quantum processors.

A quantum processor (q-processor) uses the unique nature of superposed quantum states to perform computational tasks. In the particular realms where quantum mechanics operates, particles of matter can exist in multiple states—such as an “on” state, an “off” state, and both “on” and “off” states simultaneously. Where binary or classical computing using semiconductor processors is limited to using just the on and off states (equivalent to 1 and 0 in binary code), a quantum processor harnesses these quantum states of matter to output signals that are usable in data computing. Conventional computers encode information in bits. Each bit can take the value of 1 or 0. These 1s and 0s act as on/off switches that ultimately drive computer functions. In contrast, in quantum computing, the basic unit of quantum information for a two-state quantum device is referred to as a quantum bit or “qubit” (plural “qubits”). Quantum computers operate according to two key principles of quantum physics: superposition and entanglement. For two-state systems, superposition means that each qubit can represent both a 1 and a 0 inference between possible outcomes for an event. Where a device is capable of representing a superposition of d states, with d being an integer greater than two, the basic unit of quantum information is referred to as a quantum digit or “qudit” (plural “qudits”). For instance, in a three-state system, superposition means that each qudit can simultaneously represent the 0^{th} state, the 1^{st} state, and the 2^{nd} state. Entanglement means that qubits in a superposition can be correlated with each other in a non-classical way; that is, the state of one (whether it is a 1 or a 0 or both) cannot be described independently of the state of another, and that there is more information contained within the two qubits when they are entangled than as two individual qubits.

Using these two principles, qubits (or qudits, as the case may be) operate as processors of information, enabling quantum computers to function in ways that allow them to solve certain difficult problems that are intractable using conventional computers. In machine learning, a classifier algorithm classifies data into categories. Typically, a set of training examples are each marked as belonging to a category, and a training algorithm builds a model that assigns new examples to a particular category.

The illustrative embodiment recognizes that a quantum decision making system, such as a quantum classifier, a quantum regressor, a quantum controller or a quantum predictor, may be used to analyze input sensor data and make a decision regarding the input sensor data by a quantum classifier. For example, a quantum classifier, such as a quantum support vector machine (QSVM), may be used to analyze input sensor data and determine a discrete classification of the input sensor data by a quantum processor. In other examples, regressors, controllers, or predictors may operate on continuous space entities. A quantum classifier, such as a QSVM, implements a classifier using a quantum processor which has the capability to increase the speed of classification of certain input data.

Additionally, the sensor data collected can be used for more accurate predictions about the current and future state of a physical site. The predictions can include latent characteristics of the physical site that are not directly measured, but are instead inferred, derived, or predicted based on found interactions, relationships, or correlations of measured characteristics for the physical site at the block, management unit, plant, animal, and even individual fruit level.

The predictions can be leveraged for more accurate operation of automated machinery for the planting, maintaining, and harvesting of plants or animals in a given region. For example, the predicted characteristics of growing medium at the physical site, e.g., a predicted water-holding capacity for the growing medium, can be used as input for an irrigation system that modifies the rate of irrigation of the site in response to the predicted characteristics. Further, the predicted characteristics can correspond to management units smaller than a typical block or field in which physical sites have been typically organized. As a result, operation of automated machinery, e.g., an irrigation systemin the previous example, can vary dramatically across the physical site, which can result in improved crop yield relative to operation across the entire site. The predictions can also drive improvements to a site characterization system, by identifying additional locations for obtaining sensor data that can be used to train models which can further improve the characterization and prediction of site characteristics.

A digital soil core can be generated through sensor data collected using probes that, as described in this specification, configured with a plurality of different sensor units that take a sequence of measurements starting from the surface level of a growing medium, up to a terminal depth level. Digital soil core sensor data can include the condition, behavior, interactions, and emergent properties of: light and other forms of electromagnetic radiation; molecular elements; molecules and assemblages of molecules; organismal components including cells and assemblages of cells into microbial, plant, or animal organs; individual organisms; population of organisms; species communities and ecosystems; biogeochemical cycles such as the water, nitrogen, carbon, phosphorus, energy, and other cycles; weather and climate; and physical and mechanical conditions including soil structure and site topography. Different measurements can be taken by different sensor units.

A sensor profile is a heterogeneous or homogeneous collection of data acquired using one or more sensors that comprise a plurality of measurement values along one or more axes of differentiation. Examples of axes of differentiation include sensor modalities, ranges of sensitivity including frequency and wavelength ranges, and spatial or temporal variability. For example, the measurement values returned by a collection of soil sensors that includes tip stress, sleeve friction, electrical conductivity, and moisture content from a first depth level at a coordinate may constitute a sensor profile, as may also the values measured by a single sensor from a plurality of depth levels at a coordinate. A still more complex example of a sensor profile is the values measured by a collection of sensors from a plurality of depths at a coordinate.

Likewise, the wavelength-dependent reflectance spectrum measured from a portion of a plant is another example of a sensor profile. The reflectance spectrum may represent the sensor data from one pixel which together with the other pixels in a multi-spectral image comprise a two-dimensional sensor profile of spatially differentiated spectra in a scene. As a further non-limiting example, a time series of multispectral images acquired from and geo-referenced to coordinates in the same management unit is a sensor profile of the temporal trajectory of spatial variation in the spectral reflectance of plants in the management unit.

The resulting “sensor profile” not only represents a rich vector of features for measured characteristics to be processed by a machine learning model, but the machine learning model can be trained to produce more accurate predictions by using the temporal relationship between each feature. The temporal relationship refers to the fact that the measurements by the different sensor units are taken in close temporal proximity to one another at the measured location, which can yield more accurate predictions by a model over a processed profile that includes different measurements taken minutes, hours, or days apart from each other.

The latter case often arises when sampling is performed ex situ such as when growing medium, plants and plant parts or animals are removed from a site and analyzed at a different location versus in situ. In the example of removing growing medium as part of measurement can degrade the accuracy of the measurements taken or make some measurements outright impossible, and by consequence, the accuracy of any predictions taken from measurements obtained in that matter. By techniques described in this specification, not only are sensor profiles of measured locations within a physical site enriched by quick succession of in situ measurements but measurements taken in this manner can reduce or eliminate measurement inaccuracy by minimally disturbing the measured characteristics of the physical location.

Further, by techniques described in this specification, a conventional or quantum computer usable program product is provided comprising a computer-readable storage device, and program instructions stored on the storage device, the stored program instructions comprising a method for site characterization in deep learning systems using classical computing systems or hybrid classical-quantum computing systems. The instructions are executable using a conventional or quantum processor. Another embodiment provides a computer system comprising a conventional or quantum processor, a computer-readable memory, and a computer-readable storage device, and program instructions stored on the storage device for execution by the processor via the memory, the stored program instructions comprising a method for site characterization.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example site characterization and analysis system.

FIG. 2 shows an example probe sensor unit used for digital soil coring.

FIG. 3 is a flowchart of an example process for predicting characteristics of a physical site for present and future plant development.

FIG. 4 is a flowchart of an example process for training a machine learning model.

FIG. 5 shows a graphical representation of a block partitioned into a plurality of management units according to common characteristics of physical locations at each management unit.

FIG. 6 is a flowchart of an example process for generating a spatial pattern.

FIG. 7 is a flowchart of an example process for performing orthorectification. Like reference numbers and designations in the various drawings indicate like elements.

FIG. 8 shows an example user interface for managing a physical site according to management units having different common characteristics.

### DETAILED DESCRIPTION

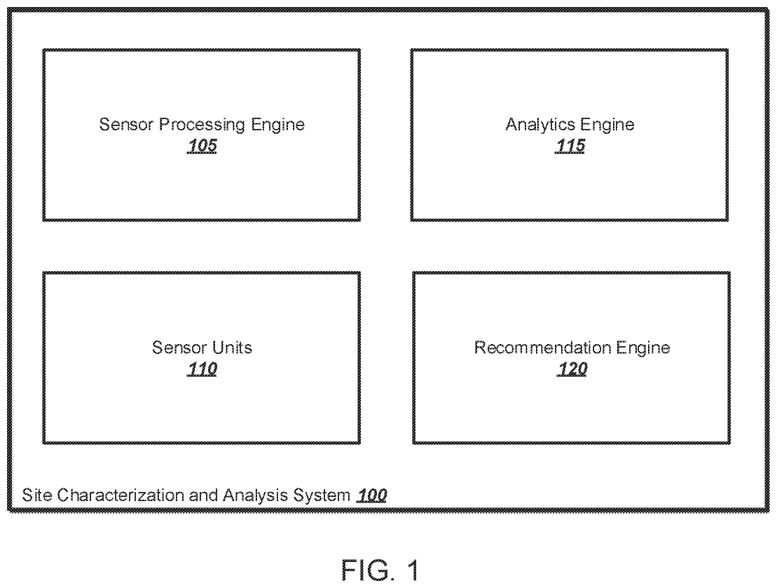

FIG. 1 shows an example site characterization and analysis system 100. The system 100 includes a sensor processing engine 105, a plurality of sensor units 110, an analytics engine 115, and a recommendation engine 120. In general, the system 100 is implemented on one or more computers and is configured to obtain sensor data, process the sensor data, predict characteristics for a physical site from which the sensor data was obtained, and generate recommendations for agricultural and forestry planning and management of the physical site in the context of system sciences and approaches addressing relationships, interactions, emergent properties, and constraints of biological, economic, social, regulatory, and political systems in the agricultural, food, forestry, and environmental supply chains and larger socio-economic market and non-market dynamics.

Although the sensor processing engine 105, the plurality of sensor units 110, the analytics engine 115, and the recommendation engine 120 are shown as part of the system 100, in some implementations, the separate components are part of different systems implemented on different binary/classical and/or quantum computer(s) communicatively linked, e.g., by a network or wired connection, to the computer(s) implementing the system 100. For example, sensor data may be stored in a database and the steps described by the various illustrative embodiments can be adapted for automatic quantum searching of the databases using a variety of components that can be purposed or repurposed to provide a described function within a data processing environment, and such adaptations are contemplated within the scope of the illustrative embodiments. Software applications may execute on any quantum data processing component in system 100.

A physical site in this specification generally refers to land of interest for current production, or future agricultural or forestry development for economic or non-economic purposes. A physical site can be of any dimension ranging from less than 1 acre to large contiguous areas of cultivated farmland, grasslands, forestlands, and combinations of these areas. The physical site need not currently be in a condition to support growing plants, animals, or other agricultural and forestry products. Rather, the term “physical site” is used as a shorthand to refer to land analyzed by techniques described in this specification for predicting characteristics of the land, including characteristics related to growing conditions for current and future agricultural, forestry, and environmental applications.

A physical site includes growing medium—which can be natural, e.g., soil, man-made, e.g., sawdust, or a combination of both types. Growing medium generally refers to any material in which an agricultural and forestry product can be produced. Examples of growing medium include soil, peat, wood chips, wood fibers, sand, perlite, and gravel.

A physical site can be divided into a plurality of “management units.” Management units are demarcations of physical sites, e.g., a field in the physical site. Management units can correspond to farms, ranches, pasturelands, forests, fields, orchards, vineyards, athletic pitches, golf courses, and other units of land demarcated by ownership, management, physical, biological, regulatory, economic or other characteristics that can be used to define boundaries between management units of a physical site. Management units can be further subdivided into smaller and smaller units based on more granular biological, physical, chemical, economic, regulatory, political, or other defined or derived characteristics that can be used to demarcate boundaries useful for planning and management. Management units can be geo-spatiotemporally static or dynamic expanding or contracting in physical size through time due to changes in measured, inferred, derived, or predicted biological, chemical, physical, or socio-economic factors or characteristics, e.g., changes in market supply and demand, regulations, political boundaries, etc. In this specification, management units are sometimes referred as “blocks” or “sub-blocks” referring to smaller portions than even a block, such a row of trees in an orchard, grouping of vines in a vineyard, cluster of annual plants in a field, or individual trees, vines, plants, or animals in a physical site.

Characteristics may be measured, inferred, derived, or predicted biological, chemical, physical, socio-economic, regulatory, or political units of continuous, discrete, binary or quantum measurements or attributes. Measurable characteristics may be measured by the plurality of sensor units 110 that specify some information about the condition of the physical site, including weather, climate and other environmental conditions of the physical site; the condition, behavior, interactions, and emergent properties of light and other forms of electromagnetic radiation, molecular elements, molecules and assemblages of molecules, organismal components including cells and assemblages of cells into microbial, plant, or animal organs, individual organisms, population of organisms, species communities and ecosystems; biogeochemical cycles such as the water, nitrogen, carbon, phosphorus, energy, and other cycles; and physical and mechanical conditions including soil structure and site topography. Characteristics may also include quantum and quantum mechanical conditions, behaviors, interactions, and emergent properties that can be measured, inferred, derived, or predicted from measures by sensor units 110. Characteristics can be geo-spatiotemporally static or dynamic. Predicted characteristics refer to categories of information about the physical site that may or may not be directly measured by the plurality of sensor units 110, but are instead predicted, e.g., using one or more machine learning models implemented by the analytics engine 115. Characteristics can be combined to form one or more indexes each being a categorical or numeric value that summarizing or condenses the information expressed in a plurality of quantitative or qualitative indicators. For example, crop yield can be an index made up of a variety of different measured or predicted characteristics that provide an overall score for quickly assessing the crop yield potential for a physical site such as the number, color, size of developing peaches on a tree. Crop health is another example, and in general characteristics can be combined as convenient to produce an index for any sought-after quality. Other examples include soil classification, soil health, soil inventory, pest or disease susceptibility, and crop suitability. Different indices can be generated that assess the same quality, e.g., crop yield, but using different combinations of characteristics. For example, one index for crop yield can be formed from characteristics related to the biogeochemical composition of the growing medium and plants at the physical site, while another index for crop yield can be formed from characteristics related to the water-holding capacity of the growing medium and other related characteristics. These specific indexes for a common quality such as crop yield can be more instructive in some cases for the contribution of the characteristics in the index towards the quality of the physical site, as opposed to an index that aggregates many more (potentially) unrelated characteristics.

The plurality of sensor units 110 are deployed according to various techniques for obtaining sensor data relating to a physical site. Sensor units can be deployed to measure specific physical locations within the physical site, general conditions of the physical site as a whole, or a combination of the two. One example is a digital soil core.

A physical location is a point in the physical site from which sensor data is/are collected. A physical location refers to growing medium at a corresponding coordinate up to a predetermined depth level below the surface of the growing medium, and also refers to the surface of the growing medium. In some implementations, the air and space above the physical location, up to a predetermined distance above the surface, is also considered as part of the physical location. A coordinate for a physical location can be specified according to any coordinate system, e.g., by a geolocation system such as GPS or GLONASS, or by a locally implemented coordinate system relative to a fixed point in the physical site.

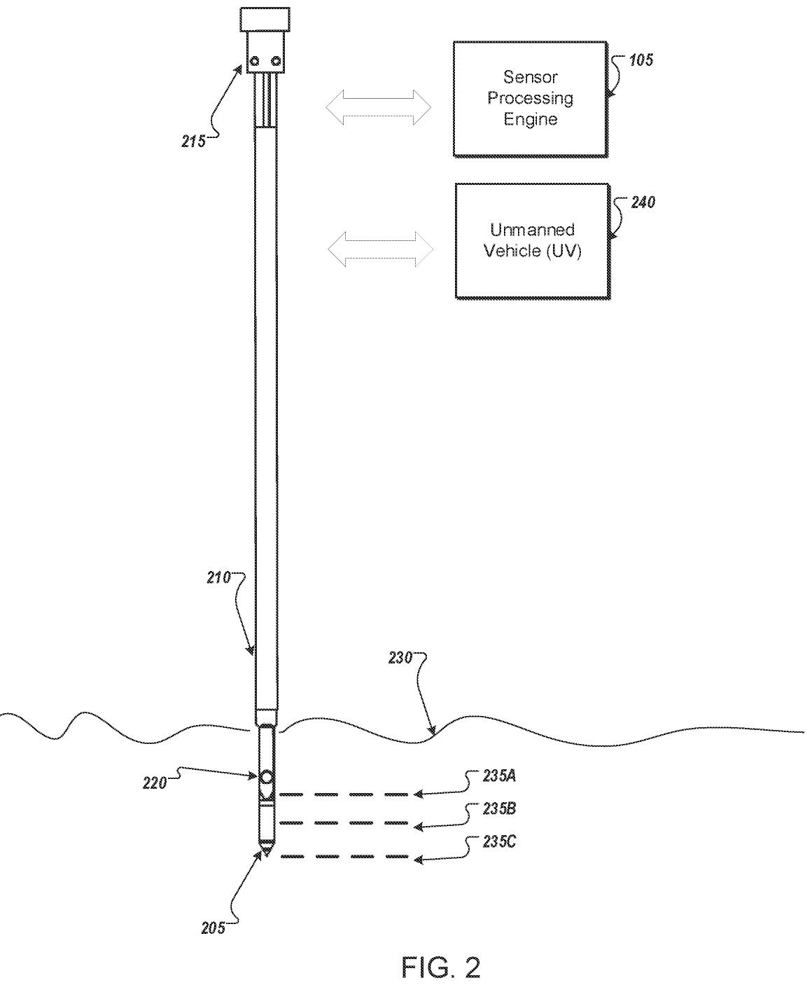

The system 100 is configured to facilitate deployment of the plurality of sensor units 110 for measuring characteristics of a physical site. In some implementations, the system 100 facilitates the measurement of different characteristics of the physical site by a combination of vehicles, stationary devices, and other machines, e.g., satellites. Sensor units can be deployed to the physical site through ground-based unmanned vehicles (UVs) or manned vehicles, unmanned or manned aerial vehicles. Sensor units can also be deployed on overhead mobile platforms, e.g., aerial drones, manned and unmanned aircraft, satellites for obtaining images and other data related to the physical site, e.g., weather stations, soil moisture and temperature sensors, imaging spectrometers, thermal cameras or minirhizotrons. Sensor units can also be fixed on stationary devices deployed at the physical site. For sub-surface (of the growing medium) measurements, probe sensor units can be inserted into the growing medium, as described in more detail below with reference to FIG. 2. The combination of above-ground, surface-level, and below-ground geo-spaciotemporal data can be aggregated into “data cores” for analytical and management purposes.

The sensor units can each implement a variety of different sensors, and different sensor units can be configured to obtain unique types of sensor data, e.g., sensor units specialized for sub-soil measurements versus sensor units specialized for vegetation or soil-surface measurements. Any combination of sensor units can be implemented for measuring surface, sub-surface, and atmospheric conditions of locations of a physical site.

The types of sensors that can be implemented by a sensor unit generally fall into two categories: non-invasive and invasive sensors. In this specification, “invasive” sensors are sensors that require physically interacting with the growing medium or plant to obtain a sensor measurement, while “non-invasive” sensors are sensors that do not require physical interaction to obtain a sensor measurement.

Examples of non-contact sensors include RADAR sensor(s), LIDAR sensor(s), (e.g., Scatter-LIDAR sensor(s)), electromagnetic sensor(s) and gamma ray sensor(s), multi-spectral imaging sensor(s), and spectroscopic sensor(s). Examples of contact sensors include stress/strain sensor(s), pressure sensor(s), and sensor(s) that measure characteristics from a growing medium or plant sample, which typically involves collecting, e.g., by ground- or drone-based UV, a sample of growing medium or plant at a given physical location. Other examples of sensors include sensors that track and measure physical properties of liquid as the liquid flows through the growing medium, as well as sensors that measure molecular, chemical, and biochemical properties of different compounds present in the growing medium and vegetation.

In some implementations, the sensor units 110 are deployed at a physical site that is not currently in agricultural use, and therefore may not have plants growing that can be measured for additional data. In other implementations, the sensor units 110 are deployed in a non-domesticated site, e.g., a site that has not been prepared for agricultural use. In those cases, the sensor units 110 can collect data pertaining to wild vegetation growing at the site. Vehicles or satellites that include a sensor unit and that are deployed for sensor data collection at the physical site can be configured to collect spectral and geometric data for individual plants, including leaves, branches, and fruit or vegetables on the plant, if present.

Spectral and geometric data, e.g., matter composition, shape, size, and structure of the plants, are two examples of the types of data that vehicles, satellites, stationary devices, and other machines can collect using one or more of the plurality of sensor units 110. However, in general, the plurality of sensor units 105 can implement any combination of sensor units to perform any measurement of interest.

The sensor processing engine 105 is configured to receive sensor data from the plurality of sensors 110, and to process the measurements to obtain sensor profiles for each physical location measured by the sensors, including by a probe sensor unit as described in more detail below with reference to FIG. 2.

A sensor profile is a composite representation of sensor data for a physical location, collected by various sensors. A sensor profile may be a heterogeneous or homogeneous collection of data acquired using one or more sensors that comprise a plurality of measurement values along one or more axes of differentiation. Examples of axes of differentiation include sensor modalities, ranges of sensitivity including frequency and wavelength ranges, and spatial or temporal variability. For example, the measurement values returned by a collection of soil sensors that includes tip stress, sleeve friction, electrical conductivity, and moisture content from a first depth level at a coordinate may constitute a sensor profile, as may also the values measured by a single sensor from a plurality of depth levels at a coordinate. A still more complex example of a sensor profile is the values measured by a collection of sensors from a plurality of depths at a coordinate.

Likewise, the wavelength-dependent reflectance spectrum measured from a portion of a plant is another example of a sensor profile. The reflectance spectrum may represent the sensor data from one pixel which together with the other pixels in a multi-spectral image comprise a two-dimensional sensor profile of spatially differentiated spectra in a scene. As a further non-limiting example, a time series of multispectral images acquired from and geo-referenced to coordinates in the same management unit is a sensor profile of the temporal trajectory of spatial variation in the spectral reflectance of plants in the management unit. An example is the generation of a digital vegetation signature based on the aggregation and analysis of wavelength-dependent reflectance spectrum.

The sensor profile for a physical location includes sensor data collected for the growing medium at the physical location at different depth levels, as well as characteristics of plants growing at or near the physical location, topography, environmental conditions, e.g., air temperature, wind speed, rainfall, and any other characteristics, e.g., as described above, that can be used to describe the physical location. The probe sensor unit can take a sequence of measurements by different sensors on the probe at the same depth level and within a small time period, e.g., a few seconds. The co-temporality of these measurements can allow for more accurate measured and predicted characteristics, as described in more detail, below.

In some implementations, the sensor processing engine 105 is configured to generate fingerprints, or hashed values, of some or all characteristics of a sensor profile. The fingerprint generated can identify the sensor profile as a whole and provide a quick and compact reference to compare the sensor profile to other sensor profiles. Alternatively, or in addition, the sensor processing engine 105 is configured to generate separate fingerprints for different characteristics or groups of characteristics represented by the sensor profile. For example, the sensor profile can include a “sub-surface” fingerprint generated from sub-surface characteristics in the sensor profiles, and also include a “vegetation” fingerprint generated from characteristics measured from plants at the physical location corresponding to the sensor profile.

The sensor processing engine 105 can group different measured characteristics from a plurality of sensor profiles and generate data structures representing composite characteristics. For example, a multi-dimensional array included in a sensor profile can represent characteristics of the growing medium across a plurality of physical locations, up to a given depth-level of the growing medium. The sensor processing engine 105 can generate the array to include characteristics measured at different physical locations, supplemented with interpolated, extrapolated, or otherwise inferred characteristics for un-measured locations that are present and between measured locations, as described in more detail, below.

The sensor processing engine 105 can implement any technique for inferring characteristics for un-measured locations, including using predicted characteristics from the analytics engine 115, as well as historical data for the physical site. The multi-dimensional array can be included in the sensor profile corresponding to any physical location represented in the array, and the sensor processing engine 105 can periodically update inferred values within the array of a sensor profile in response to additional sensor profiles and predicted characteristics of the site from the analytics engine 115.

In addition to updated inferred values within the array in response to additional sensor profiles and predicted characteristics of the site, the sensor processing engine 105 can also extrapolate, or otherwise infer characteristics for un-measured locations of the physical site according to a variety of other techniques. In general, some characteristics are more consistent over a long period of time (called “temporally stable”), and therefore can act as good indicators for inferring other characteristics related to those consistent characteristics. For example, certain site-wide characteristics are measured, e.g., using any remote-sensing techniques, e.g., aerial imagery, to infer that locations with similar geographic or geologic characteristics, e.g., the topography of the physical region, share other similar characteristics, e.g., soil classification. The reasoning is that some geographic and geological characteristics, e.g., topographic characteristics, tend to remain the same or vary very little relative to other characteristics, e.g., weather conditions, availability of plant roots at a given location, and water-holding capacity for growing medium at the location.

The sensor processing engine 105 can also extrapolate or infer characteristics based on previously predicted characteristics for the physical site. For example, through techniques described in this specification for processing sensor profiles of measured locations through one or more statistical models, correlations can be identified between a temporally stable characteristic and other measured or predicted characteristics. Those correlations can be used to infer or extrapolate characteristics at un-measured locations.

The sensor processing engine 105 can be implemented on computer(s) remote from the physical location at which sensor unit(s) are measuring data, or in some implementations, implemented on computer(s) that are part of a mobile or stationary station located at the physical site where measurements are being taken. As an example, the sensor processing engine 105 can be implemented on the cloud, and communicatively connected to receiving units, e.g., radio transmitters, configured to receive and transmit data from the sensor units to the sensor processing engine 105.

The sensor processing engine 105 is configured to send sensor profiles to the analytics engine 115, and the analytics engine 115 is configured to predict characteristics for the physical location. As described with examples below, in some implementations certain more widely available and easier-to-implement sensor units, such as audio and imaging sensors, are used to predict other characteristics, e.g., a soil layer classification of a physical location, through correlations learned by trained machine learning models implemented by the analytics engine 115. Predicted characteristics can also include characteristics of the physical location that are only known through a combination of separate measurements, e.g., a predicted water retention capacity through multiple soil layers at the physical location.

The recommendation engine 120, as described in more detail below, is configured to receive predicted characteristics from the analytics engine 115, and provide analysis, discovery, and decision support, e.g., decision support systems in agriculture and forestry, including instructions for managing a physical site at different levels of granularity, i.e., different management units at the block, management unit, or individual plant level, that can be executed by automated agricultural equipment configured to perform tasks, e.g., planting, pruning, harvesting, irrigation, fertilization, and pest control, for site management.

FIG. 2 shows an example probe sensor unit 200. As described above with reference to FIG. 1, a probe sensor unit can be used to obtain sensor measurements for use in generating sensor profiles for physical locations in a physical site. The probe 200 can be one of many sensor units used to obtain sensor measurements at different locations of a physical site.

The probe 200 is generally of an elongated cylinder shape, with a uniform diameter of about an inch. In some implementations, the probe 200 is not of a uniform diameter, but has a maximum diameter of about an inch. The length of the probe 200 can vary from implementation to implementation as a range of multiple dimensions varying in probe length, width, and weight. For example, the probe 200 can be 56 centimeters in length. In general, the thin and elongated design of the probe 200 allows for measurements of the growing medium at different depth levels, while minimally disrupting the growing medium and improving the accuracy of the measurements, i.e., because growing medium disruption can reduce the accuracy of the measurements.

The probe 200 and the sensor processing engine 105 can be communicatively coupled over a wireless connection, e.g., over a local or wide area network, or a wired connection, e.g., a coaxial cable, physically connecting the probe 200 to one or more computers implementing the sensor processing engine 105. The probe 200 includes a tip 205, shaft 210, and base 215, and a plurality of sensors 220. Although the plurality of sensors 220 are depicted in FIG. 2 as between the shaft 210 and the base 215, sensors in some implementations can be on any part of the probe 200, including on the tip 205, the shaft 210, and the base 215.

In general, different implementations of the probe 200 include different combinations of sensors of the types described above with reference to FIG. 1, with the aim of measuring different characteristics of the growing medium 230, such as water holding capacity, organic matter composition, bulk density, chemical composition, growing medium class, and fertility. Any combination of sensors can be implemented on the probe 200 to obtain measurements for characteristics of the growing medium 230 that might be relevant to the behavior and quality of plants currently planted in the physical site or planned for planting. In one implementation, all of the sensors described below are included on the probe 200.

Examples of the sensors that can be implemented on the probe 200 also include tip force sensor(s), sleeve friction sensor(s), soil moisture sensor(s), electrical resistivity sensor(s), electrical conductivity sensor(s), video camera(s), (e.g., imaging sensors, including spectroscopic sensor(s), near-infrared/infrared sensor(s), charge-coupled device imaging sensor(s), and thermal sensor(s)), time-domain reflectometer(s), gamma sensor(s) and audio sensors (e.g., sonic sensor(s) and microphone(s), including micro electro-mechanical system microphone(s) and complementary metal-oxide-semiconductor microphone(s)).

When the probe 200 implements a sonic sensor, the probe 200 measures the sound of the probe 200 as it is pushed through the growing medium 230. The sound of the probe 200 can be used to measure growing medium texture, as interaction of the probe with different textures produces sound in distinct ways. The sound of the probe 200 can also be used to detect the presence and quantity of gravel or rocks as well as changes in soil density. In some implementations in which the probe 200 includes a thermal sensor, the probe 200 additionally includes a heating element to raise the temperature of the growing medium 230 as the probe 200 is inserted. Then, the thermal sensor measures a heating or cooling profile for the growing medium 230. Spectroscopic sensor(s), e.g., infrared, near-infrared, mid-infrared, laser-induced fluorescence, and Raman spectrometers can be used for identifying chemical, biological, mineralogical or other characteristics of the growing medium 230. Other examples include the quantification of minerals, including clay minerals and metals; quantification of nitrogen, phosphorus, and potassium, i.e., an N-P-K label, in the growing medium; and quantification of other chemical elements or compounds of interest.

Some sensors are configured to obtain measurements for the same characteristics. For example, an imaging sensor is configured to take images of a growing medium while a sonic sensor measures sound produced by interaction of the probe 200 with the growing medium as the probe 200 is inserted. In this example, both sensors are configured to take measurements corresponding to soil texture, which is received by the sensor processing system 105. The soil texture can be discerned either visually (through received images taken by the imaging sensor) or auditorily (through sounds measured by the sonic sensor), or by a combination of both measurements, as described in more detail below.

A tip force sensor is located at the tip 205 of the probe 200 and measures bearing strength for the growing medium 230, which is closely related to tip stress on the tip force sensor as the probe 200 is inserted into the growing medium 230. A sleeve force sensor is located between the tip 205 and the shaft 210 of the probe 200 and measures sheer strength for the growing medium 230. Sheer strength is closely related to sleeve friction as the probe 200 is inserted into the growing medium. Sheer strength is controlled by growing medium texture, i.e., grain size distribution; and compaction, which is related to the bulk density of materials making up the growing medium 230. The measurements from the tip force sensor and the sleeve force sensor can be combined to provide a measure of soil strength.

The probe 200 can be inserted, e.g., by a human or robot operator, to take measurements of the growing medium at different depths. For example, the probe 200 can be inserted by a UV 240, deployed to a physical site. In addition to the sensors of the probe 200, the UV 240 can include a variety of invasive and non-invasive sensors that are configured to obtain sensor data from physical locations as described above with reference to FIG. 1. This additional sensor data can be provided to the sensor processing engine 105 for generating a sensor profile.

The probe 200 is configured to obtain a plurality of measurements, including one or more measurements for each of the plurality of sensors 110, as the probe is inserted through depth levels 235A, 235B, and 235C of the growing medium 230. The probe 200 can be inserted at a predetermined depth, e.g., two feet, five feet, six feet; and speed, e.g., 2 centimeters per second, with measurements taken at a plurality of depth levels between the surface of the growing medium 230 and the terminal depth level, along predetermined depth intervals, e.g., 3 inches apart. As the probe 200 passes through a depth level, sensors of the probe 200 take measurements in a sequence, starting with sensors closest to the tip 205, and ending with sensors closest to the base 215 of the probe 200. The probe 200 can also take measurements at the depth intervals 235A-C as the probe 200 is retracted from the growing medium 230, beginning at the terminal depth level and ending at the surface of medium. The probe 200 can also be stopped if need be for measurements with sensors.

The sequence of measurements taken at the depth level allow for a more robust and accurate overall measurement of characteristics of the growing medium at the depth level, for several reasons. First, the measurements in sequence are taken at a controlled rate, i.e., the rate at which the probe 200 is inserted into the growing medium 230. This allows for direct control over the measurements to mitigate the risk of inaccurate measurements of a growing medium that has already been disturbed by sensors during an initial measurement.

Second, measurements taken in sequence provide for a more accurate differentiation of different layers of growing medium. If the growing medium is soil, then the soil may have several soil layers, with each soil layer having different characteristics distinct from characteristics of neighboring layers. For example, while the probe 200 collects static data in sequence for each of the plurality of sensors 220 as the sensors pass through the depth levels 245A-C, the probe 200 is also collecting dynamic data representing changes in characteristics of the growing medium between, e.g., the depth level 245A and the depth level 245C. Changes in growing medium strength, color, and moisture at different depth levels can also be indicative of changes in texture and hydraulic characteristics, e.g., growing medium behavior with respect to wetting, drying transmission of water, and water holding capacity, with depth.

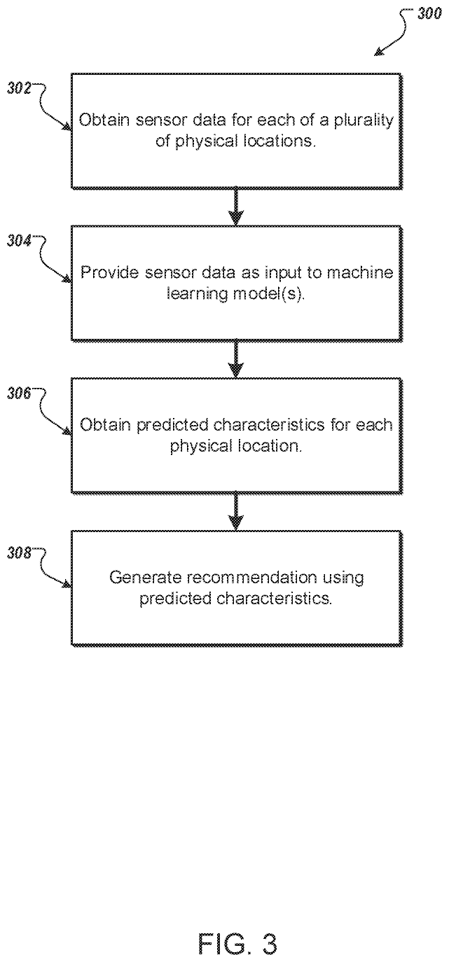

Third, as those sensors on the probe 200 travel through the ground the sensors measurements are taken at a time interval. These measurements from different sensor units for the same characteristics can be combined by the system 100 to “sharpen” or improve an overall measurement by the plurality of sensors 220, as described below with reference to FIG. 3. However, the sensors are offset in space. Furthermore, each sensor measure is representative of a differ volume of soil, the electromagnetic or physical force projecting into the soil at different distances and with different geometries. In addition, each sensor could be recorded at a different interval. Some sensors, such as an imaging sensor comprise a number of measurements that can be attributed to multiple depths in each image. Data from each sensor can be aligned according to its physical position on the probe 200 and readings interpolated to the highest resolution sensor using a method incorporating, for instance, the statistical covariance of the other sensors, or any other suitable method of interpolation. This produces a high-resolution feature set which can then be use in a machine learning algorithm for the prediction of soil property profiles.

The resulting soil property profiles together form a feature set for the interpolation of the soil properties. The average value of a property may be determined at a certain depth for each profile then the results of the value of each of the properties across all of the profile locations can be interpolated, resulting in a two-dimensional grid of values. The process is repeated at other depth intervals to create a 3-dimensional stack of the two-dimensional grids. While this process, lines up with the way it is known that sediment is laid down, the process of soil formation is primarily vertical. One or more statistical methods may be employed to determine the probability of a profile similar to each measured profile from the surrounding area, then a statistical model is employed to predict the mostly likely vertical profile at that location. This prediction can be performed on a grid of any ground resolution to produce a 3-dimensional model. The 3-dimensional model can be of any vertical resolution but is informed by the high-resolution vertical profiles. In creating the modeled profiles, the neighboring modeled profiles can be considered to ensure a smooth horizontal transition between profiles. It is also contemplated that a profile growth model can be performed that is trained and constrained by the measured profiles. Such a model would be similarly constrained by neighboring profiles. Another benefit of this approach is that it can be used over large areas that at are sparsely sampled by taking advantage of diverse landscape characteristics related to the growing medium parent materials, vegetation, climate, topography, and human interventions.

Combination of sensor unit measurements can be particularly helpful to certain characteristics, such as growing medium structure or growing medium health, which are generally difficult to accurately quantify. Measurements by sensors earlier in the sequence and at a given depth level can be improved by measurements of sensors later in the sequence at the given depth level.

A vehicle can be driven to a physical site and physically deploy a plurality of UVs for obtaining measurements at the site, e.g., the UV 240 can be deployed to physically insert the probe 200 into the growing medium 230. Some deployed UVs are configured to insert probes into the growing medium at different physical locations, and the probes provide sensor data to the sensor processing engine 105 implemented on computer(s) in the vehicle. After the sensor data is provided to the sensor processing engine 105, the UV 240 can receive an indication of a next location for obtaining a new measurement, from the system 100. As described in more detail, below, the system 100 can use the predicted characteristics to determine locations for subsequent measurement, which can be labeled according to predicted characteristics inferred by the system 100, and used to re-train one or more machine learning models implemented by the analytics engine 115 for characteristic predictions.

FIG. 3 is a flowchart of an example process 300 for predicting characteristics of a physical site for present production and future agricultural, forestry, or environmental development. For convenience, the process 300 will be described as being performed by a system of one or more computers, located in one or more locations, and programmed appropriately in accordance with this specification. For example, a site characterization and analysis system, e.g., the site characterization and analysis system 100 of FIG. 1, appropriately programmed, can perform the process 300.

The system obtains 302 sensor data for each of a plurality of physical locations in the physical site. The plurality of physical locations can be determined in a variety of different ways. In some implementations, locations to be measured are determined randomly. In some implementations, locations are initially specified such that locations are equidistant from each other. Alternatively, or in addition, the locations can be hand-selected based on relative interest for different portions of the physical site. The physical locations can also be determined where information about a physical region is already rich—to supplement or to confirm existing measurements; or poor—to quickly bootstrap site characterization where information is most needed. In some implementations, sensor data is collected across the entire site remotely, e.g., using imaging sensors mounted on drones, aircraft, or satellites. In those implementations, before determining the initial locations for measuring near-ground, surface or sub-surface characteristics, the system analyzes data collected from the remote sensing, and determines initial locations for measuring to cover different regions that correspond to different measurements according to the remote sensing. For example, the system can determine initial locations on either side of a water feature, e.g., a river, dividing the physical site. Because remote sensing is generally faster to implement than near-ground, surface or sub-surface sensing, the system can make informed determinations about where best to start obtaining near-ground, surface or sub-surface sensor data that can result in quicker and more accurate analysis over a random initialization.

Initial locations can also be hand-selected according to planned operational decisions for a physical site. For example, a physical site in which plants are grown may see a certain percentage, e.g., ten percent of the total site, replanted each season. If the locations for replanting are predetermined, some physical locations within the replanting region can be selecting for measuring, to allow for quicker collection and analysis of data at a particular region of interest within the physical site.

For each location, the sensor data includes a respective sensor profile generated from measurements taken by each of a plurality of contact and non-contact sensors on sensor units, e.g., sub-surface probe, surface-level unit, above-ground unit, and sensors units mounted on drones, planes or satellites.

The sensor profile may include static and dynamic measurements, depending on the sensors implemented on the sub-surface probe, surface-level unit, above-ground unit, or sensors units mounted on drones, planes, or satellites. Sensor data may include the condition, behavior, interactions, and emergent properties of: light and other forms of electromagnetic radiation; molecular elements; molecules and assemblages of molecules; organismal components including cells and assemblages of cells into microbial, plant, or animal organs; individual organisms; population of organisms; species communities and ecosystems; biogeochemical cycles such as the water, nitrogen, carbon, phosphorus, energy, and other cycles; weather and climate; and physical and mechanical conditions including soil structure and site topography. In the example of the sub-surface probe, the measurements can be taken at depth levels up to a terminal depth level, and in some implementations, measurements are also taken as the probe is retracted from the growing medium. In addition, the sensor data can also include a rate of change for measured characteristics as a function of depth level of the location measured. For example, the sensor data can include a rate of change of soil moisture of soil at a measured location starting from the surface level up to the terminal depth level measured. The smoothness of the gradient calculated from the measurements can be adjusted based on how many depth levels are measured while the probe sensor unit is inserted at the physical location.

The sensor data is provided 304 to one or more machine learning models configured to receive the sensor data that includes the sensor profiles, and to predict one or more characteristics of the growing medium at each of the physical locations. The characteristics can be specific to different management units of the physical site; a block or sub-block of the site; a management unit of the site, i.e., a physical area within a block identified by the analytics engine 115 as sharing similar predicted characteristics; a physical location and land proximate to the physical location, e.g., within a threshold distance such as 1 meter; or an individual plant, plant organs e.g. tubers, roots, leaves, stocks or fruit that can be harvested from the plant.

The one or more machine learning models can be configured according to a variety of different techniques for processing the sensor data. In some implementations, a single machine learning model receives and processes all of the sensor data. Alternatively, multiple machine learning models can be configured to receive different characteristics represented in the sensor data. For example, one or more the machine learning models can be a convolutional neural network that receives characteristics corresponding to visual features of the measured physical location, e.g., images showing soil density or soil grain-size. The convolutional neural network can process those characteristics representing visual features of the soil and can generate predicted characteristics corresponding to those input characteristics. Alternatively, the network can pass an intermediate output to another model that is configured to receive that intermediate output and generate predicted characteristics. As another example, the one or more machine learning models can include a neural network including quantum components such as a quantum neural network.

The system obtains 306 the one or more predicted characteristics of the growing medium as output from the machine learning model(s) of the analytics engine 115. Regardless of the specific techniques used to train the corresponding models of the analytics engine 115, the granularity of the sensor data provided allows for identifying very specific correlations between many latent features of the provided data, and the desired characteristics. Specifically, because sensor profiles can provide very specific spatial (i.e., down to depth levels of a physical location) and temporal (i.e., a sequence of measurements taken at controlled rate at a depth-level of a physical location) measurements, corresponding predictions of characteristics can be made with equal specificity.

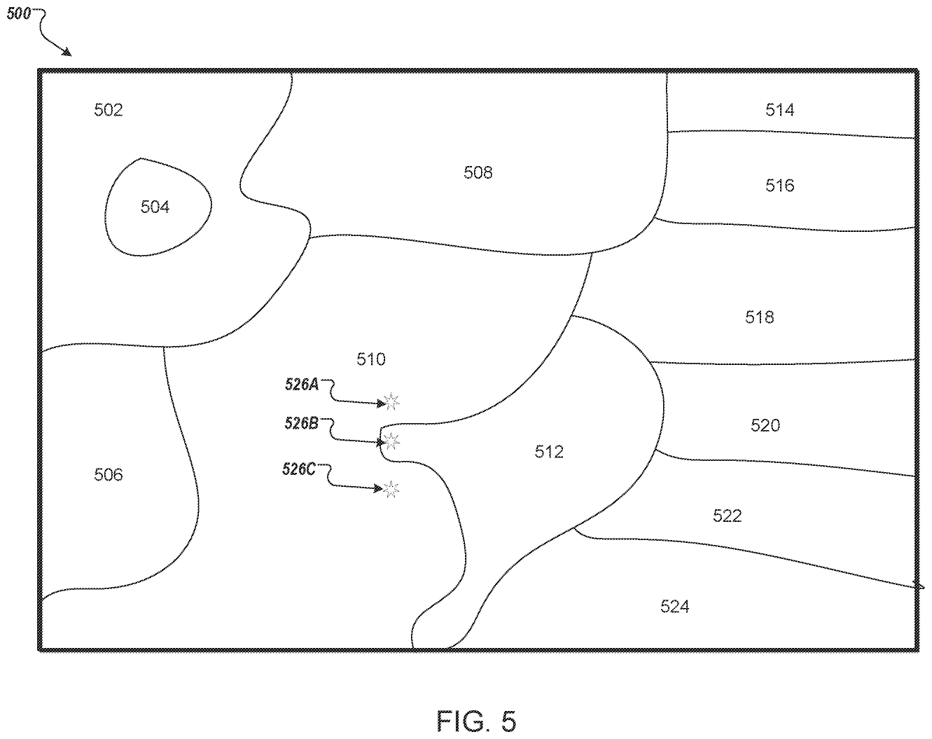

By making use of granular sensor data as described above, the recommendation engine 120, described below, can provide equally specific recommendations for management units within a block, i.e., management units, whereas previously data was obtained and analyzed at only the site or block level. Further, the predicted characteristics can be used to identify management units of a physical site where growing medium and plants share similar characteristics, e.g., by comparing predicted characteristics with sensor profile fingerprints (described above with reference to FIG. 1). The management units can be as large as the site that encompasses it, or as small as the area around an individual plant and spanning any distance and shape within the block. An example is provided below, with reference to FIG. 5.

The predicted characteristics can include static characteristics (e.g., a chemical composition, a bulk density) as well as dynamic characteristics, (e.g., fluid characteristics, including a soil-liquid retention curve such as a soil-water retention curve, hydraulic conductivity and plant-available liquid within the growing medium, and liquid-containing nutrients, all measured as respective functions of the depth of the growing medium. Examples of predicted characteristics also include a grain size distribution, a compaction state, a moisture condition, a texture, a liquid retention capacity including water retention capacity, an organic matter content state, a bulk density, a cation exchange capacity, a pH value, a salinity value, and a chemical composition.

Predicted characteristics can also include plant yield data, in both the quality and quantity of the harvested units e.g., fruits, leaves, shoots, tubers, roots, animals, etc. throughout a current or future season, even in cases in which the plants have not actually been planted yet; and plant health during a current or future season. Predicted characteristics can also include plant market data, including predicted pricing and demand in response to received sensor profile data supplemented with market trend data. Predicted characteristics can also include economic characteristics or characteristics beyond purely biophysical characteristics. For example, predicted characteristics can include characteristics for a predicted economic value of a physical location assuming the growth and harvest of a corresponding plant at the location.

The machine learning model can be from one or more machine learning models trained to predict characteristics of the growing medium or the physical location in general. The model(s) can be implemented according to any known statistical learning technique, including neural networks, convolutional neural networks, Bayesian inference, generative adversarial networks, decision tree models, and Markov Chain Monte Carlo. The system 100 can train the machine learning model(s) according to any appropriate machine learning technique.

For example, the machine learning model(s) can be trained on sensor profiles labeled with corresponding characteristics a respective machine learning model is being trained to predict. Specifically, a machine learning model can process input sensor data profiles, also called “sensor profiles,” and generate one or more predicted characteristics. The system 100 can compute a measure of error between the predicted characteristics and the actual characteristics corresponding to the sensor profiles, and use the error to update, e.g., using a backpropagation technique, parameter values that modify the operations of the machine learning model.

Initially, the training data can be hand-labeled or derived from previous measurements prior to deploying sensor units for site characterization for a given site. For example, the training data can be from a previously measured site known to exhibit similar characteristics as a currently analyzed site or from a plurality of sites known to exhibit a range of characteristics. Once the machine learning models have predicted characteristics for input sensor profiles, the system 100 can facilitate obtaining additional sensor data from previously un-measured locations that are identified by the analytics engine 115 as likely to have similar predicted characteristics. The machine learning model(s) can use any objective function, e.g., mean absolute error, mean square error or cross-entropy loss, for computing an error.

One example of architecture for a machine learning model implemented by the analytics engine 115 is a neural network having a plurality of layers, including an input layer, an output layer, and one or more hidden layers. Input to the neural network can be the sensor profiles represented as a vector, array, or tensor of characteristics. Output of the neural network can be a vector of predicted characteristics corresponding to the input sensor profiles. The objective function used in training the neural network can measure a loss between ground-truth and predicted characteristics vectors. An example function is one that maximizes a dot product between the vectors, where a dot product of 1 indicates parallel vectors. Another example function is one that optimizes a dynamic time warping measure of similarity between profiles. The ground-truth value may or may not be a previously measured characteristic. In some implementations, the ground-truth value may be itself the output of a machine learning model configured to predict a particular characteristic, e.g., flux for a liquid in the growing medium, or soil-water content over time.

The analytics engine 115 can identify candidate locations for measurement based on different factors, e.g., distance from a measured location with predicted characteristics, or the location of a candidate location proximate to other measured locations having similar characteristics or predicted characteristics. For example, the analytics engine 115 can use fingerprints of respective sensor profiles to identify corresponding locations with similar characteristics, and infer that an unmeasured location within a predetermined threshold, e.g., 1 meter, is also likely to have the same or similar predicted characteristics.

After identifying candidate locations, the system 100 can deploy one or more sensor units of the plurality of sensor units 110 to the candidate locations, to obtain respective sensor profiles, as described above with reference to FIG. 1. The newly obtained sensor profiles can be labeled with the inferred characteristics predicted to correspond with the candidate locations and used as part of additional training data for updating parameter values of machine learning model(s) of the analytics engine 115. In effect, the analytics engine 115 of the system 100 can be improved over time from additional sensor profiles from the sensor processing engine 105. The analytics engine 115 can inform the plurality of sensor units 110 of candidate locations likely to improve the quality of site characterization, obviating the need to measure the location at each coordinate of a physical site, while still providing the granular sensor data used to generate the predicted characteristics and subsequent recommendations of the recommendation engine 120.

To facilitate faster indications of next locations for vehicles operating sensor units, the analytics engine 115 is configured to receive and process predicted characteristics in real time. In some implementations, the analytics engine 115 identifies candidate locations for measurement based on anomalous characteristics predicted at one or more physical locations. Anomalous characteristics can be characteristics that fall above or below a predetermined threshold, e.g., low predicted maximum water retention for a plurality of physical locations in a region historically known to have soil with high water retention. In response to characteristics falling above or below the predetermined threshold, the analytics engine 115 can facilitate additional measurements at a candidate physical location nearby to the anomalous locations. In this way, the analytics engine 115 can prompt a “forensic” investigation, for example by a UV, to automatically obtain additional information for additional sensor profiles and determine whether the predicted characteristics truly were anomalous or indicative of a larger pattern within the site.

The richness and variety of the obtained sensor profiles dovetails with the expanded computational capacity of quantum computing and other future improvements to computing capable of handling sensor data at an order of magnitude that is in some cases intractable by classical computing techniques, e.g., in some cases in which models receive highly variable weather or climate data. As described in more detail, below, high spatial granularity can relate to high temporal granularity in management units, and a corresponding machine learning model configured to predict characteristics as described in this specification may need to do so on an hourly or even minute-by-minute basis. Dynamic and complex models implemented by the analytics engine 115 and the recommendation engine 120 for characteristic prediction and recommendation, respectively, can fully take advantage of quantum computing to process high-resolution sensor data for more accurate outputs.

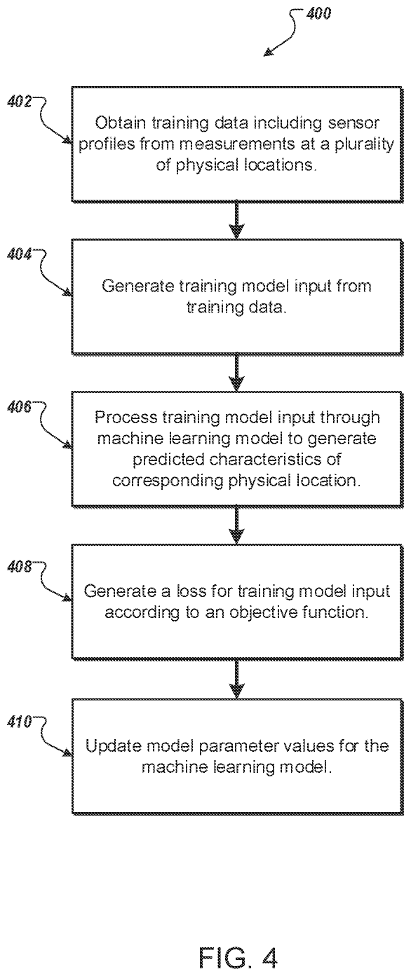

FIG. 4 is a flowchart of an example process 400 for training a machine learning model. For convenience, the process 400 will be described as being performed by a system of one or more computers, located in one or more locations, and programmed appropriately in accordance with this specification. For example, a site characterization and analysis system, e.g., the site characterization and analysis system 100 of FIG. 1, appropriately programmed, can perform the process 400.

The system obtains 402, for each of a plurality of physical locations corresponding to a respective coordinate at a surface of growing medium at the plurality of locations, training data including a sensor profile. As described above with reference to FIG. 1, the sensor processing engine 105 generates the sensor profile from measurements taken by each of a plurality of sensors on a sensor unit passing through the respective coordinate at a plurality of different depth levels within the growing medium at the location, where the sensor unit passes through each depth level in a sequence. Each of the plurality of sensors performs a respective measurement at the depth level, while the sensor unit passes through the depth level, starting at the surface and proceeding until a terminal depth level.

As described above with reference to FIGS. 1-3, the sensor profile can include additional remote sensor information, collected for the surface of the growing medium at the location, as well as for air and space located at the coordinate, up to a predetermined distance.

The system generates 404, from the training data, a plurality of training model inputs, including a first training model input. The model inputs can be sensor profiles having corresponding labels, where the labels are ground-truth characteristics for which the machine learning model is being trained to predict. As described above with reference to FIG. 3, the labels can be generated by hand, using historical data from the physical site, or automatically using predicted characteristics for previously analyzed sensor profiles that are within a threshold of similarity with the sensor profiles in the training data, or a combination of the two.

The system processes 406 the first training model input including a first sensor profile through the machine learning model to generate one or more predicted characteristics for a first physical location corresponding to the first sensor profile. The system generates 408 a loss for the first training model input according to an objective function that measures an error between (i) a label for the first training model input and (ii) the one or more predicted characteristics for the first physical location. For example, the loss measured can be an absolute difference or sum of absolute differences between the predicted characteristics for the sensor profile, and the characteristics according to the label. After the loss is measured, the model parameter values for the machine learning model is updated 410 using the loss.

The process 400 can repeat until a stopping condition is met, i.e., a set number of iterations or a length of time. The machine learning model can be subsequently re-trained according to new data, as a result of which the model parameter values can be updated in response to a measured loss for new training inputs. The trained model can then be implemented by the analytics engine of the system for predicting characteristics for new physical locations whose sensor profiles have not appeared in training data.

In implementations in which different models are trained to predict the same characteristics, the analytics engine is configured 115 to aggregate predicted characteristics from the models and provide an aggregated predicted characteristic as output to the sensor data. For example, the aggregated predicted characteristic can be an average of the predicted characteristics generated by each machine learning model.

As one example of a predicted characteristic, the ability of soil to hold water in an area is a function of the thickness of each layer of soil, combined with the contents at each layer. As described above with reference to FIGS. 1 and 2, a sensor profile includes measurements taken at a physical location (designated by a coordinate) at varying depth levels. The sensor profile for the location therefore can include measurements for growing medium density, and friction, color, and moisture content at each layer penetrated by a probe. While none of the sensors directly measure the ability for the soil to hold water at the physical location directly, the analytics engine 115 can employ one or more models to receive the sensor profile to predict a maximum water retention quantity for the soil at the physical location measured, given sensor profiles that include measurements as the foregoing.

The analytics engine 115 can correlate different characteristics in the sensor data to identify correlations to other characteristics previously thought to be uncorrelated or weakly correlated. Making full use of the richness of the sensor data allows for distinguishing between plants in a site even where the plants are genetically identical. For example, sub-surface characterization can be integrated with additional plant data, e.g., obtained from sensors measuring geometric and spectral characteristics of the plant, as described above with reference to FIG. 1.

The sensor data can be supplemented with data from additional sensor units. For instance, spectral information from overhead imaging spectrometers can provide information about bare soil, as well as about plant canopy. The combination of measurements taken at a sub-surface, surface, and aerial level can further result in identified correlations between characteristics directly measured by the plurality of sensor units 110, and characteristics of the physical location that are not directly measured but rather inferred according to the directly measured characteristics by the one or more machine learning models of the analytics engine 115.

As described above, management units can be defined according to one or more predicted characteristics, e.g., characteristics predicted by the system 100 of FIG. 1. The granularity of the obtained sensor data can result in predicted characteristics for small, e.g., plant-level and fruit-level, management units. In addition, the predicted characteristics for the smaller management units allows for better insight on changes to the region at that management unit over smaller units of time. Hour-to-hour or day-to-day changes are generally more pronounced in smaller management units over larger management units, and with the available sensor data the system can be configured to predict characteristics more frequently for smaller management units than larger management units. This, in turn, allows for more specific and frequent recommendations for agronomic management at those smaller management units.

FIG. 5 shows a graphical representation of a block 500 of a physical site partitioned into a plurality of management units 502-524 according to common characteristics of physical locations at each management unit. The management units 502-524 each represent physical locations within the block 500 sharing a threshold number of common characteristics, i.e., characteristics inferred, derived or predicted by the analytics engine 115 based on sensor profiles corresponding to different physical locations, e.g., physical locations 526A-C. As described above, the analytics engine 115 can facilitate subsequent measurements based on inferred characteristics at candidate locations within a physical site. The analytics engine 115 can iterate identifying candidate locations, predicting characteristics, and identifying new candidate locations for a set number of iterations or a length of time. After which, the analytics engine 115 is configured to demarcate blocks within the physical site by management units, e.g., the management units 502-524.

Although the graphical representation shown in FIG. 5 is a simple example, the management units 502-524 are shown to be non-uniform, in shape, orientation, and size. Additionally, some management units may be encompassed by other management units, e.g., management unit 502 and management unit 502. Differences in characteristics at different locations drive boundaries established by the analytics engine 115 for the different management units. For example, the physical locations 526A and 526C share similar characteristics, e.g., within a predetermined threshold, establishing them in the management unit 510, with other locations with similar characteristics (characteristics that were generated as a result of processing respective sensor profiles by the analytics engine 115, or inferred by the techniques described above with reference to FIG. 3). On the other hand, the physical location 526B has characteristics that are different enough from the characteristics of the physical locations 526A and 526C to merit placement in the management unit 512.

The analytics engine 115 can update boundaries of the management units within the block 500, e.g., in response to new sensor data for newly measured locations, or changes to the physical site with the passage of time, or both. After the analytics engine 115 generates a management unit demarcation for a block, the demarcation can be used as an initial guideline for other blocks in the site, so as to facilitate initial measurements at the subsequent block believed to share similar characteristics and characteristics with the previously analyzed block.

This arrangement of management units as shown in FIG. 5 highlights a departure from purely site-level or block-level organization of physical sites, which can result in inaccurate or inefficient management practices, as different parts of the block are assumed to be homogeneous when in reality are not. Recommendations generated by the recommendation engine 120, as described below, can target individual management units. For example, best management practice for the management unit 504 may be an irrigation schedule that is significantly different than that of management unit 502. Had management practice been left at the block level for determining best irrigation practice, it is likely that the management unit 502, the management unit 504, or both, would be subjected to an inefficient irrigation schedule.

Although FIG. 5 shows several management units, as described above with reference to FIGS. 1 and 3, the analytics engine 115 can predict characteristics at a level more granular than that of a block, including up to a plant, individual fruit or animal. However, the effect of the granularity of sensor data and the corresponding granularity of predicted characteristics is an organization of a physical site that allows management of the site to be tailored and optimized at a precise level. Individual plants or animals can be separate management units, and coherent decision making and management is made possible even for such small management units, even when the corresponding physical site is often several acres in area.

In some implementations, management units and other management units are closely related to the time at which corresponding predicted characteristic were generated by the analytics engine 115. This is because the accuracy of the predicted characteristics varies as time goes on from the initial characterization. In these cases, the system 100 is configured to routinely obtain predicted characteristics from physical locations at different management units or management units to continuously provide up-to-date and relevant information.

One or more of the implemented machine learning models of the analytics engine 115 for predicting characteristics can be used to improve a previously measured characteristic of a physical location that is represented in the sensor data. For example, measurements for different layers of a growing medium can be effectively disaggregated, so that a spatial pattern can be generated from the sensor data and that clearly demarcates where different layers begin and end. While both audio and imaging sensors separately can measure information corresponding to a soil layer classification at a physical location, a machine learning model of the analytics engine 115 can be trained to receive sensor profiles including both audio and video information taken at different depth levels at a physical location and close in time, to produce a more accurate classification of each soil layer at the physical location than by using audio or video information alone.

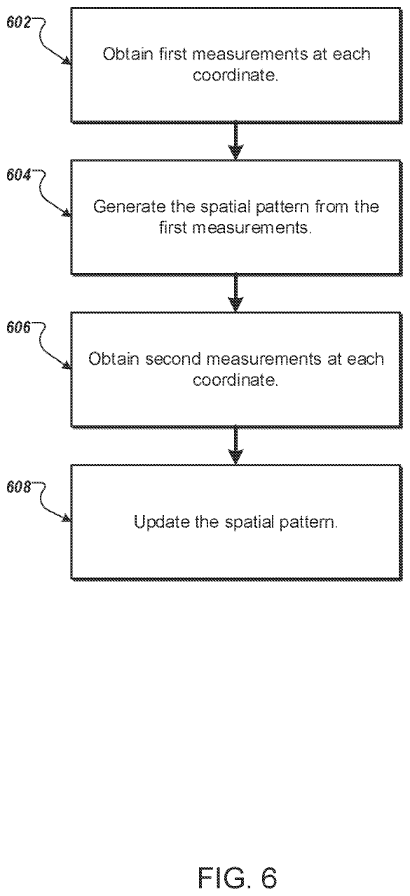

Other combinations of sensors can also be used, as described below with reference to FIG. 6. Disaggregating different layers of a growing medium using a combination of video and audio sensors can help avoid the need of relatively more complex sensor implementations on the probe, like tip force and sleeve friction sensors, which can also be configured to quantification different layers of the growing medium.

FIG. 6 is a flowchart of an example process 600 for generating a spatial pattern. For convenience, the process 600 will be described as being performed by a system of one or more computers, located in one or more locations, and programmed appropriately in accordance with this specification. For example, a site characterization and analysis system, e.g., the site characterization and analysis system 100 of FIG. 1, appropriately programmed, can perform the process 600.

The system obtains 602 at a given coordinate, and by a first one or more sensors, respective first measurements of a physical location at the coordinate, including measurements at a plurality of depth levels. For example, the system obtains audio measurements using an audio sensor on a probe. Recall that a plurality of sensors can be present on a probe, as described above with reference to FIG. 2. The system generates 604 the spatial pattern using the obtained respective first measurements. The spatial pattern quantifies different distinct layers of growing medium detected from the first measurements.

The system obtains 606 at a given coordinate, and by a second one or more sensors different from the first one or more sensors, respective second measurements of the physical location at the coordinate, including measurements at the plurality of depth levels.

The system updates 608 the spatial pattern using the respective second measurements. For example, the analytical engine 115 can process the first and second measurements, i.e., as part of a sensor profile, through a machine learning model, e.g., a convolutional neural network, configured to generate an updated spatial pattern. For example, the sound of perturbations of the growing medium can be measured as a probe is inserted. Sound is recorded by the probe passing through different depth levels of a growing medium, and an imaging sensor on the probe takes a picture of the growing medium at each corresponding depth level. The closeness in time between the two measurements is facilitated by a probe design that can minimize disruptions in the growing medium, as described above with reference to FIG. 2, and allows for a strong correlation to be made between the respective measurements taken by the respective sensors.

As another example, initial first measurements can be taken by a tip force sensor, a sleeve sensor, or a combination of the two on the probe as the probe is being inserted into the growing medium. Together, these measurements can be processed by the analytics engine 115 to generate a coarse version of a spatial pattern for the physical location. Along the sequence of measurements by the plurality of sensors on the probe can be the audio sensor, the imaging sensor, or both sensors. These sensors take additional measurements that can be used by the analytics engine 115 to refine the spatial pattern using the additional data collected.

The richness of sensor data collected allows for improved spatial pattern interpolations and extrapolation of characteristics of growing medium and plants at physical locations not directly measured by the system 100. As another example, small-scale topographic and spectral reflectance characteristics of surface growing mediums can be strong indicators of the distribution of water holding capacity of nutrients within a block.

The combination of sensor profiles for individual physical locations and remote sensing, e.g., from drone, aircraft or satellite imagery can be exploited for improving geo-registration and calibration of images taken of the physical site. Monthly, weekly, or more frequent images may be collected over the same physical area. However, to facilitate the use of machine learning to use that imagery for change detection and to model the growth of individual plants, the imagery should be adequately georeferenced and spectrally calibrated. Shifts in georeferencing of imagery collected at two different times could result in apparent temporal change where there is none, or the cancelling out of change where it exists. The georeferencing error should be less than the error in the ground spacing distance of the analyzed imagery. Similarly, when imagery is collected repeatedly, differences in illumination, instrument orientation, altitude, direction of travel, and especially variations between sensors can interfere with the ability to analyze change quantitatively.

The method may enable appropriate spatial and spectral calibration of the sensor data. The method may include masking of information-rich pixels, using information-rich pixels to define spectral control points defined by end point conditions observed on the ground, e.g., bright vs. dark soil, soil vs. vegetation, green vegetation vs. yellow vegetation, the transformation of the multi-dimensional data from one feature space, into a new multi-dimensional feature space, in which at least two dimensions are orthogonal and then scaling the orthogonal dimensions between spectral control points, resulting in calibrated vegetation indices that are less noisy than some other methods. Additional crop specific parameters may also be used to adjust the scaling to particular crops. These indices may also be combined with thermal data in further statistical analysis to identify potential causes of plant stress and yield development. The thermal data may need to be scaled by the size of the canopy. The canopy size can be estimated from vegetation indices and the resulting surface model from the orthorectification process.

One product of an aerial survey is a ground elevation model, another product is a surface model. The surface model represents the ground in some places, low vegetation in others, and trees and building in yet other locations. The surface model can be used in creating the information rich pixel mask, and the information rich pixel mask can be used as above to obtain a vegetation index. The land surface can be segmented into the ground, vegetation, trees, and buildings through a statistical algorithm that incorporates vegetation indices and surface elevations. The algorithm may also take into account texture and shape of features derived from the data. The land surface segmentation may be classified by the same and the land classification may be used for further masks and calibrations. The resulting data can be used to develop management units or identify individual plants and the associate the attributes of individual plants to the plant location in a plant database.

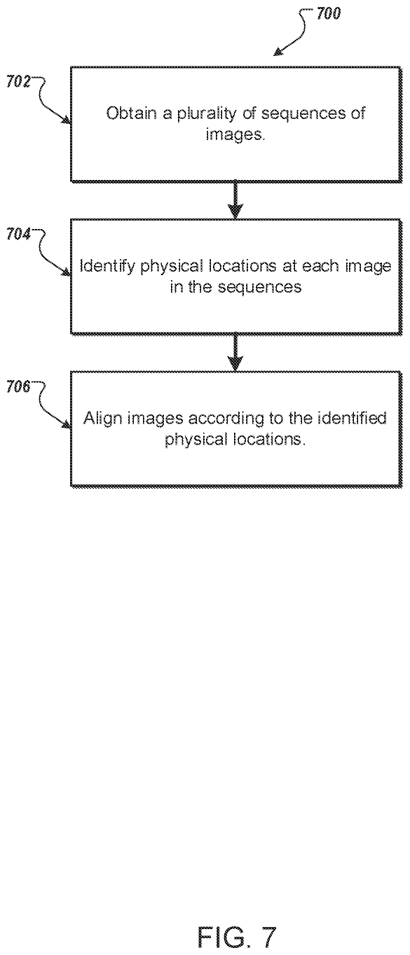

FIG. 7 is a flowchart of an example process 700 for performing geo-registration and calibration. For convenience, the process 700 will be described as being performed by a system of one or more computers, located in one or more locations, and programmed appropriately in accordance with this specification. For example, a site characterization and analysis system, e.g., the site characterization and analysis system 100 of FIG. 1, appropriately programmed, can perform the process 700.

The system obtains 702 a plurality of sequences of images, each sequence of images mapping a physical site that includes a plurality of physical locations. The system then performs orthorectification for each sequence.

The system identifies 704 in each image of the sequence and using respective sensor profiles corresponding to the physical locations, the physical locations represented by the plurality of coordinates. The physical locations can be identified because the system pulls from a variety of different measurements made at the physical location to identify the physical location from the image. For example, measurements for a surface condition for the growing medium can be corroborated with corresponding pixels in the image which in turn correspond to the physical location. Other measurements, such as spectral signatures of the physical location measured by corresponding sensors, can also be used to corroborate a portion of an image as corresponding to the physical location.

The system identifies a plurality of physical locations instead of a single physical location to mitigate risk of an inaccurate alignment of the images in the sequence, although in some implementations only a single physical location is identified in each image. Once the plurality of physical locations has been identified in each image, the system aligns 706 the images according to the physical locations. In this way, the physical locations are “anchor points.” By routinely geo-registering and calibrating images by satellite of a physical site, the system can further enrich the corpus of available sensor data for the analytics engine 115 and the recommendation 120 with accurate image data that represents characteristics of the physical site at different points in time.

In some implementations, the system 100 maintains a database of predicted characteristics and corresponding sensor profiles, which can include measurements taken from different physical sites over an extended period of time. Further, the system can group characteristics according to different categories, e.g., as described above with reference to surface and sub-surface characteristics in a sensor profile having respective fingerprints. For example, the database can specify which characteristics of sensor profiles characterize various vegetation patterns, past, present, or future. Vegetation patterns can be further sub-classified by the period of time at which sensor profiles exhibiting these patterns were observed.

Additionally, sensor profiles corresponding to these characteristics are identified as being indicative of a type of vegetation pattern, and this additional classification can be provided as input to the one or more machine learning models for predicting characteristics of input sensor profiles that may share similar characteristics to those of the classified sensor profiles. As sensor profiles are processed by the analytics engine 115, the analytics engine 115 can classify the sensor profiles as falling into a plurality of different patterns, e.g., vegetation, growing medium, to be referenced for future analysis.

Returning to FIG. 3, the system generates 308 a recommendation using the predicted characteristics, handled by the recommendation engine 120 of the system 100. Types of recommendations include agronomic planning recommendations for the design, planting, and harvesting of plants in a physical site, and dynamic decision support for different issues associated with the upkeep of plants, including irrigation, fertilization, fertility management, and pest control. As with the analytics engine 115, the recommendation engine is configured to implement one or more models that receive, as input, characteristics of physical locations in a site, and generate, as output, recommendations according to the characteristics and recommendations for managing a physical site at the block, management unit, and individual plant level to eventually change characteristics of a physical site to meet predetermined external constraints or some predetermined objective. In some implementations, the recommendation engine 120 is configured to generate corresponding crop data characterizing features of crops before or after being planted at the site.

The recommendation engine 120 can provide recommendations for plant management in response to external constraints on preferred characteristics for a plant. External constraints can include market preferences, e.g., a known preference of a certain type of plant, e.g., medium sized lemons having a particular color, peel quality, and fruit juice quality. External constraints can also include constraints imposed by an entity growing and maintaining plants in a region, e.g., a requirement that plants maintain certain milestone sizes during different points of the growing and harvest season. As another example, a given region may have a target yield imposed on it, either as a function of actual plants produced and harvested from the region after a season or even a period of multiple seasons spanning years, or a target monetary goal, measured per-unit or per-harvest. External constraints can also be agronomic constraints or requirements, for example imposed by local regulations at a region for which analysis is being performed.

External constraints can also include limitations of resources for managing the physical site. For example, the external constraints can specify limitations on infrastructure, labor, and time or resources available for executing a recommendation. Similarly, the objective to be achieved in following the recommendation can also specify economic goals to be achieved in implementing a recommendation, e.g., maximizing a return-on-investment, return-on-assets, and return-on-capital. The system can make use of existing market data to update constraints and/or an objective, for example as market demand calls for shift in crop production for management units of a physical site to maximize an economic return.

With these external constraints in mind, one or more probabilistic models can be trained with training data including sensor profiles labeled with values associated with the external constraints, e.g., a plant yield for a physical location corresponding to a training input sensor profile. A probabilistic model can be a machine learning model, or any other statistical model, that takes as input predicted and directly measured characteristics of sensor profiles of physical locations of a site, and generates, as output, data corresponding to recommendations for suggested agronomic practices for management units corresponding to the sensor data. Specifically, the analytics engine 115 can process current sensor profiles through the one or more trained probabilistic models to obtain characteristics corresponding to a region's compliance under the given external constraints. The recommendation engine 120 simulates different management decisions applied to the physical site at the block, management unit, and individual plant/fruit level, to generate recommendations for modifying plant management in the physical site to achieve compliance under the external constraints.

For example, the recommendation engine 120 can provide recommendations for irrigation control of a physical site. By analyzing predicted characteristics generated from sensor profiles that include measurements for classical and molecular physical properties, the recommendation engine 120 can provide recommendations for which management units irrigation is or is not needed. Because predictions of characteristics can be made as granular as characteristics of a fruit on a plant, corresponding recommendations can be made that are similarly granular, instead of making block-level irrigation designs that may be ill-suited for many parts of the block.

The recommendation engine 120 can provide recommendations that can be used in managing a physical site to grow crops suitable for market conditions. For example, within an orchard of lemon trees, a number of lemon trees can produce market-suitable lemons, while others do not, despite the same care provided to each tree, e.g., same fertilization schedule, irrigation, pest control, etc. Trees exhibiting ideal fruit conditions can be measured, e.g., according to the techniques described above with reference to FIGS. 1 and 2, and sensor profiles can be obtained for physical locations where the lemon trees producing ideal fruit are located. The qualities of the ideal fruit, e.g., ripeness, shape, size, juice or flesh quality, can also be measured, and used as labels on the obtained sensor profiles for training the one or more probabilistic models of the analytics engine 115. Often, desired characteristics like fruit quality is readily observable, but the reason why one tree produces ideal fruit while an adjacent tree does not is often not easily discernible and requires an analysis that combines sensor data from all characteristics of the location at which the trees are growing.

Because of the granularity of information provided in the senor profile, the analytics engine 115 can produce predicted characteristics that consider ultra-specific conditions at or below the surface level of individual trees in the orchard. The resulting predicted characteristics can lend a reason as why some genetically identical trees produce more favorable fruit than other genetically identical trees in the same block or management unit.

Analyzing and predicting characteristics of plants with ideal fruits throughout a growing season can yield more accurate recommendations than if characteristics of a plant yield are analyzed at the end of a growing season. For example, an entity, e.g., a farmer or a farming company, can determine at the end of a harvest that a certain percentage, e.g., five percent, or all plants harvested exhibited ideal conditions for market. By then, however, it is virtually impossible to identify from which plants the ideal percentage of plants originated from, for example because information about from which block a particular plant was harvested from is not maintained.

Instead, plants producing ideal plants can be identified during the growing season, measured by the techniques described above with reference to FIGS. 1 and 2 and used to train a model for the analytics engines 115 to identify correlations relating the ideal plant conditions to conditions for an individual plant.

As a simple example, it may be that ideal lemons are associated with trees having a certain amount of water and nutrients provided to the root zone. The recommendation engine 120 can receive these predicted characteristics generated by the analytics engine 115 and generate a recommendation by way of an irrigation timing and volume schedule that is specific to certain parts of the block. In general, the correlations between desired characteristics and measured characteristics are likely to be quite complex, with correlations created that are likely to exceed manual statistical analysis and only suited for trained machine learning models. However, the recommendation engine 120 obscures the complex correlations to provide recommendations that can be efficiently translated to instructions implemented by automated plant management or harvesting equipment.

In general, the above-described system can be interacted with on a user interface, e.g., displayed on a computing device. The user interface can be displayed as part of a user application installed on the computing device which can be configured to send to and receive data from a user of the system 100. For example, the user interface can display measured and predicted characteristics from the system, as well as generated recommendations. In addition, the user can input requests to receive and filter specific data of interest to the user, e.g., predicted characteristics for a specific management unit in the site. In addition, the user interface is configured to receive additional data, e.g., economic data such as market information, for use in generating recommendations, as described above. The user interface can receive the additional data directly from the user, or the client application implementing the user interface can be configured to pull information from online databases, e.g., government data tracking agricultural characteristics for a site of interest.

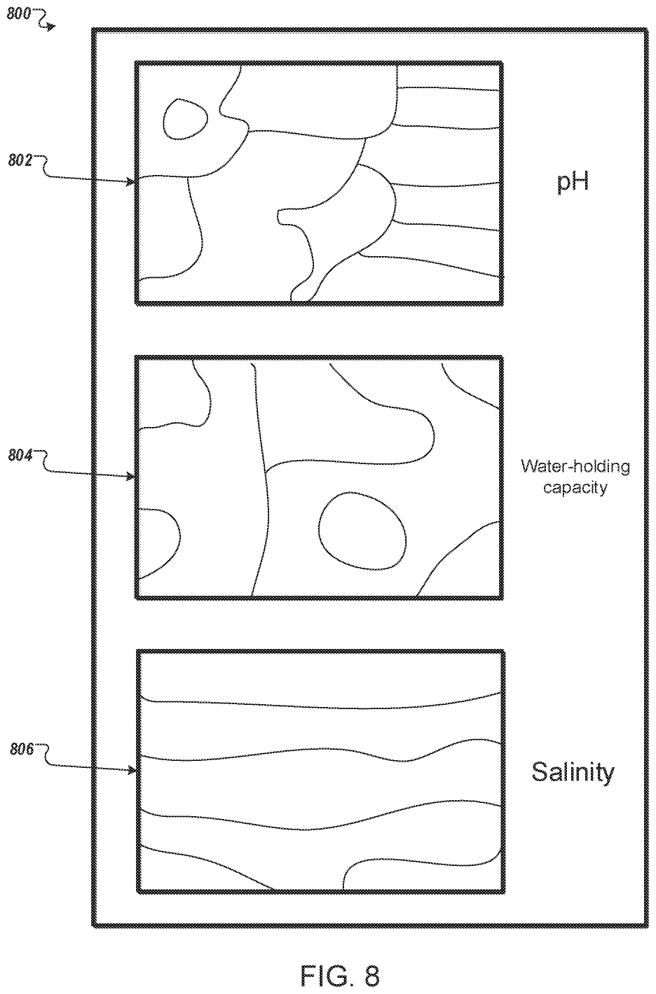

FIG. 8 shows an example user interface 800 for managing a physical site according to management units having different common characteristics. The user interface 800 can be displayed on a user device, e.g., a laptop or mobile phone. The user interface 800 shows block maps 802, 804, and 806. Each of the block maps 802-806 show management units partitioning the block according to a common characteristic. Specifically, the block map 802 shows a block partitioned by management units covering regions having similar pH values for the growing medium of the block (within a predetermined threshold). The block map 804 similarly shows management units partitioning the same block according to water-holding capacity, and the block map 806 shows management units partitioning the same block according to salinity of the growing medium across the block.

The user interface 800 is configured to receive input to adjust the threshold for similarity for determining how to partition the block according to a common characteristic. For example, the block 802 can show management units for different pH levels within a threshold of 1. The user interface 800 can receive an input, e.g., from the user using a tactile input to the display of a mobile device, or anything appropriate technique, which causes the user interface 800 to update the block map 802 according to a different pH threshold, e.g., 0.5.

The user interface 800 can generate block maps according to multiple common characteristics, e.g., soil pH and salinity. The block map can represent the management units according to the specified multiple common characteristics, which can be adjusted for different threshold values, as described directly above.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively, or in addition, the carrier may be an artificially-generated propagated signal, e.g., a machine-generated electrical, optical, or electromagnetic signal that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors, quantum computers, or any combination, or any other kind of central processing unit. Generally, a central processing unit will receive instructions and data from a read-only memory or a random-access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid-state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on one or more computers having, or configured to communicate with, a display device, e.g., a LCD (liquid crystal display) or organic light-emitting diode (OLED) monitor, a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

Implementations of the quantum subject matter and quantum operations described in this specification may be implemented in suitable quantum circuitry or, more generally, quantum computational systems, including the structures disclosed in this specification and their structural equivalents, or in combinations of one or more of them. The term “quantum computational systems” may include, but is not limited to, quantum computers, quantum information processing systems, quantum cryptography systems, or quantum simulators.

The terms quantum information and quantum data refer to information or data that is carried by, held or stored in quantum systems, where the smallest non-trivial system is a qubit (or qudit, as the case may be), e.g., a system that defines the unit of quantum information. The term “qubit” can encompass all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Quantum circuit elements may be used to perform quantum processing operations. That is, the quantum circuit elements may be configured to make use of quantum-mechanical phenomena, such as superposition and entanglement, to perform operations on data in a non-deterministic manner. Examples of quantum circuit elements include, but are not limited to, quantum LC oscillators, qubits (e.g., flux qubits or charge qubits), superconducting quantum interference devices (SQUIDs) (e.g., RF-SQUID or DCSQUID), among others.

In some implementations, quantum computational systems employ quantum circuit elements fabricated from superconducting materials. The quantum circuit elements are cooled down within a cryostat to temperatures that allow a superconductor material to exhibit superconducting properties.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining, for each of one or more physical locations each corresponding to a respective coordinate at a surface of a growing medium at the plurality of locations, sensor data comprising a sensor profile generated from measurements taken by each of a plurality of sensors on a sensor unit passing through the respective coordinate at a plurality of different depth levels within the growing medium at the location, wherein the sensor unit passes through each depth level in a sequence and each of the plurality of sensors performs a respective measurement at the depth level while the sensor unit is passing through the depth level, starting at the surface and proceeding to a terminal depth level;
providing the sensor data as input to one or more probabilistic models configured to receive the sensor data comprising the respective sensor profiles to predict one or more characteristics of the growing medium at each of the one or more physical locations; and
obtaining, as output from the one or more probabilistic models, the one or more predicted characteristics for each of the one or more physical locations.

2. The method of claim 1, wherein providing the sensor data comprises providing timestamps indicating at which respective time the sensor unit passes through each depth level.

3. The method of claim 1, wherein the sensor data further comprises remotely sensed sensor data from one or more sensors configured to measure characteristics of the physical locations at or above a surface level of the plurality of physical locations.

4. The method of claim 1, further comprising:
generating, using the one or more predicted characteristics, a recommendation for agronomic planning at a physical region that includes the one or more physical locations.

5. The method of claim 1, wherein the plurality of locations are located in a physical region, and wherein the method further comprises generating, using the one or more predicted characteristics, predicted plant yield data characterizing features of plants before or after being planted in the physical region.

6. The method of claim 1, wherein the one or more predicted characteristics are characteristics that are not directly measured by the plurality of sensors.

7. The method of claim 1, wherein the one or more probabilistic models are further configured to receive the sensor data and to predict one or more characteristics of un-measured physical locations.

8. The method of claim 1,
wherein the one or more physical locations are first physical locations, and wherein the method further comprises:
identifying, using the one or more characteristics of the growing medium, second physical locations within a predetermined distance of a first physical location of the one or more physical locations, wherein the second physical locations are different from the first physical locations and are additional physical locations at which additional measurements are needed; and
obtaining, for each of the second physical locations, sensor data comprising a sensor profile generated from measurements taken by each of a plurality of sensors on a sensor unit passing through a respective coordinate at a plurality of different depth levels within the growing medium at the second location.

9. The method of claim 1, wherein the one or more predicted characteristics comprise one or more of:
a grain size distribution of growing medium at the physical location, a compaction state of the growing medium at the physical location,
a moisture condition of the growing medium at the physical location, a texture of the growing medium,
a liquid retention capacity of the growing medium,
an organic matter content state of the growing medium, a bulk density of the growing medium, a cation exchange capacity of the growing medium, a pH of the growing medium,
a salinity of the growing medium, and
a chemical composition of the growing medium.

10. The method of claim 1, wherein the one or more characteristics comprise a liquid characteristic characterizing a liquid present in the growing medium and based on respective measurements performed at each depth level during a time period in which the sensor unit passed through each depth level until proceeding to the terminal depth level.

11. The method of claim 1, wherein the sensor unit is inserted using an unmanned vehicle.

12. The method of claim 1, wherein obtaining the sensor data further comprises:
obtaining a spatial pattern that is a classification of growing medium between the surface and the terminal depth level, wherein obtaining the spatial pattern comprises:
obtaining, at each coordinate, and by a first one or more sensors of the plurality of sensors, respective first measurements,
generating the spatial pattern using the obtained respective first measurements;
obtaining, at each coordinate, and by a second one or more sensors of the plurality of sensors different than the first one or more sensors, respective second measurements, and updating the spatial pattern using the respective second measurements.

13. The method of claim 12, wherein the plurality of first sensors comprises (i) a tip sensor measuring a tip stress as a tip of the sensor unit passes through each depth level, (ii) a sleeve sensor measuring a degree of growing medium cohesion between the sensor unit and growing medium at each depth level, or (iii) both the tip sensor and the sleeve sensor, and
wherein obtaining the respective first measurements comprises obtaining the respective first measurements using the tip sensor, the sleeve sensor, or both.

14. The method of claim 12, wherein the plurality of second sensors comprise a microphone, a spectral sensor, or an image sensor.

15. The method of claim 1, wherein obtaining the sensor data further comprises:
obtaining a plurality of sequences of images, each sequence of images mapping a physical region that includes the one or more physical locations; and
for each sequence of images, performing image geo-registration, comprising: identifying, in each image of the sequence and using respective sensor profiles corresponding to the physical locations, the physical locations represented by the plurality of coordinates; and
aligning each image according to the physical locations.

16. The method of claim 1, wherein the plurality of sensors comprises one or more of a spectral sensor, an image sensor, a microphone, a mineralogical sensor, a pressure sensor, a chemical sensor, a moisture sensor, a spectroscopic sensor, or a near-infrared/infrared sensor.

17. The method of claim 1, further comprising identifying the one or more physical locations, comprising:
obtaining data defining a vegetation pattern for a physical region, wherein the vegetation pattern in the physical region characterizes present and future vegetation across the physical region over a period of time, including characterizing present and future vegetation at a plurality of candidate locations in the physical region; and
identifying, from the plurality of candidate locations, the one or more physical locations based on respective characteristics of vegetation at the plurality of candidate locations satisfying one or more predetermined suitability criteria for identifying suitable physical locations to obtain sensor data from.

18. The method of claim 17,
wherein the one or more probabilistic models are further configured to receive, as input, the vegetation pattern for the physical region, and to predict, as output, the one or more characteristics of the growing medium at each of the physical locations using both the sensor data and the vegetation pattern for the physical region across the period of time,
wherein obtaining the data defining the vegetation pattern for the physical region comprises obtaining data defining the vegetation pattern at each of a plurality of time steps during the period of time; and
wherein providing the sensor data as input to the one or more probabilistic models comprises providing both the sensor data and the data defining the vegetation pattern for at least one of the plurality of time steps.

19. The method of claim 1, further comprising:
obtaining weather data defining weather or climate conditions for the physical region over a plurality of time steps in the period of time;
generating, using the one or more predicted characteristics and the weather data, a recommendation for agronomic planning at the physical region.

20. The method of claim 1, further comprising:
generating, from the one or more predicted characteristics, one or more growing medium profiles, wherein each growing medium profile defines, for each predicted characteristic, a respective range of values for the predicted characteristics;
obtaining sensor data for one or more second physical locations;
obtaining, as output from the one or more probabilistic models receiving the sensor data for the second physical locations, one or more second predicted characteristics for each of the second physical locations; and
assigning each of the second physical locations to one of the one or more growing medium profiles based on respective one or more predicted characteristics of the second physical location satisfying the respective range of values for each of the predicted characteristics defined in one of the one or more growing medium profiles.

21. The method of claim 1, wherein the one or more predicted characteristics include soil property profiles that form a feature set for soil properties.

22. The method of claim 4, wherein the recommendation is automatically translated into a set of instructions for controlling agronomic or forestry management equipment.

23. The method of claim 1, wherein the one or more predicted characteristics include a soil layer classification.

24. The method according to claim 1, wherein the one or more predicted characteristics are combined to form an index that is a categorical or numeric value representative of a plurality of quantitative or qualitative indicators of the plurality of physical locations.

25. The method of claim 1, wherein the sensor profile is representative of at least one measurement of the sensor unit selected from the measurements consisting of a growing medium density, friction, color, tip stress, electrical conductivity and moisture content at each layer penetrated by the sensor unit.

26. The method of claim 1, wherein the sensor data is further processed by at least one quantum processor to obtain more accurate outputs compared to outputs obtained based on one or more classical processors alone.

27. The method of claim 1, wherein the one or more predicted characteristics are further evaluated by at least one quantum processor.

28. A method of training a machine learning model,
wherein the machine learning model has model parameter values and is used to generate one or more predicted characteristics for physical locations indicated by coordinates, and wherein the method comprises:
obtaining, for each of a plurality of physical locations corresponding to a respective coordinate at a surface of growing medium at the plurality of locations, training data comprising a sensor profile generated from measurements taken by each of a plurality of sensors on a sensor unit passing through the respective coordinate at a plurality of different depth levels within the growing medium at the location, wherein the sensor unit passes through each depth level in a sequence and each of the plurality of sensors performs a respective measurement at the depth level while the sensor unit is passing through the depth level, starting at the surface and proceeding until a terminal depth level;
generating, from the training data, a plurality of training model inputs, including a first training model input;
processing a first training model input comprising a first sensor profile through the machine learning model to generate one or more predicted characteristics for a first physical location corresponding to the first sensor profile;
generating a loss for the first training model input according to an objective function that measures an error between (i) a label for the first training model input and (ii) the one or more predicted characteristics for the first physical location; and
updating the model parameter values for the machine learning model using the loss.

29. The method of claim 28, wherein the method further comprises processing sensor data defining measurements of data taken at a plurality of physical locations of a physical region through the trained machine learning model to predict one or more characteristics of growing medium at each of the physical locations of the physical region.

30. A system comprising:
one or more computers and one or more storage devices on which are stored instructions that are operable, when executed by the one or more computers, to cause the one or more computers to perform operations comprising:
obtaining, for each of one or more physical locations each corresponding to a respective coordinate at a surface of a growing medium at the plurality of locations, sensor data comprising a sensor profile generated from measurements taken by each of a plurality of sensors on a sensor unit passing through the respective coordinate at a plurality of different depth levels within the growing medium at the location, wherein the sensor unit passes through each depth level in a sequence and each of the plurality of sensors performs a respective measurement at the depth level while the sensor unit is passing through the depth level, starting at the surface and proceeding to a terminal depth level;
providing the sensor data as input to one or more probabilistic models configured to receive the sensor data comprising the respective sensor profiles to predict one or more characteristics of the growing medium at each of the one or more physical locations; and
obtaining, as output from the one or more probabilistic models, the one or more predicted characteristics for each of the one or more physical locations.

31. One or more computer-readable storage media encoded with instructions that, when executed by one or more computers, cause the one or more computers to perform operations comprising:
obtaining, for each of one or more physical locations each corresponding to a respective coordinate at a surface of a growing medium at the plurality of locations, sensor data comprising a sensor profile generated from measurements taken by each of a plurality of sensors on a sensor unit passing through the respective coordinate at a plurality of different depth levels within the growing medium at the location, wherein the sensor unit passes through each depth level in a sequence and each of the plurality of sensors performs a respective measurement at the depth level while the sensor unit is passing through the depth level, starting at the surface and proceeding to a terminal depth level;
providing the sensor data as input to one or more probabilistic models configured to receive the sensor data comprising the respective sensor profiles to predict one or more characteristics of the growing medium at each of the one or more physical locations; and
obtaining, as output from the one or more probabilistic models, the one or more predicted characteristics for each of the one or more physical locations.
